(19) United States
(12) Patent Application Publication
(10) Pub. No.: US 2019/0217834 A1
(43) Pub. Date: Jul. 18, 2019

(54) Hydraulic Control Apparatus and Brake System

(71) Applicant: Hitachi Automotive Systems, Ltd., Hitachinaka-shi, Ibaraki (JP)

(72) Inventors: Ryohei MARUO, Kawasaki-shi, Kanagawa (JP); Chiharu NAKAZAWA, Kawasaki-shi, Kanagawa (JP)

(21) Appl. No.: 16/304,572

(22) PCT Filed: May 8, 2017
(86) PCT No.: PCT/JP2017/017334

§ 371 Date: Nov. 26, 2018

(30) Foreign Application Priority Data
May 27, 2016 (JP) 2016-106289

(51) Int. Cl. B60T 13/62; B60T 8/48; B60T 8/40; B60T 13/18; B60T 13/16; B60T 13/66; B60T 13/68

(52) U.S. Cl. CPC B60T 13/62; B60T 8/48; B60T 8/4081; B60T 13/18; B60T 13/167; B60T 2270/403; B60T 13/686; B60T 2270/82; B60T 2270/402; B60T 2270/404; B60T 13/662

(57) ABSTRACT

Provided is a hydraulic control apparatus and a brake system capable of improving responsiveness in terms of increasing a pressure in a wheel cylinder. The hydraulic control apparatus includes a connection fluid passage connected to a wheel cylinder of a wheel, a first hydraulic source, and a second hydraulic source. The first hydraulic source includes a first discharge port connected to the connection fluid passage and a first intake port connected to a reservoir storing brake fluid therein. The second hydraulic source includes a second discharge port connected to the connection fluid passage and a second intake port connected to the reservoir.

### TECHNICAL FIELD

The present invention relates to a hydraulic control apparatus and a brake system.

### BACKGROUND ART

Conventionally, there has been known a hydraulic control apparatus including redundantly configured hydraulic control actuators for adjusting hydraulic pressures in wheel cylinders (for example, PTL 1).

### CITATION LIST

### Patent Literature

[PTL 1] International Publication No. 2014/184840

### SUMMARY OF INVENTION

### Technical Problem

One of objects of the present invention is to provide a hydraulic control apparatus and a brake system capable of improving responsiveness in terms of increasing the pressures in the wheel cylinders.

### Solution to Problem

According to one embodiment of the present invention, a hydraulic control apparatus includes a connection fluid passage connected to a wheel cylinder of a wheel, a first hydraulic source, and a second hydraulic source. The first hydraulic source includes a first discharge port connected to the connection fluid passage and a first intake port connected to a reservoir storing brake fluid therein. The second hydraulic source includes a second discharge port connected to the connection fluid passage and a second intake port connected to the reservoir.

Therefore, according to the one embodiment of the present invention, it is possible to improve the responsiveness in terms of increasing the pressures in the wheel cylinders.

### BRIEF DESCRIPTION OF DRAWINGS

FIG. 1 illustrates a schematic configuration of a brake system BS according to a first embodiment together with a hydraulic circuit.

FIG. 2 illustrates an operation of the brake system BS according to the first embodiment at the time of normal braking.

FIG. 3 illustrates an operation of the brake system BS according to the first embodiment at the time of autonomous emergency braking.

FIG. 4 illustrates an operation of the brake system BS according to the first embodiment when a fluid leak failure has occurred in a P system.

FIG. 5 illustrates an operation of the brake system BS according to the first embodiment when a failure has occurred in a second pump.

FIG. 6 is a schematic view of a hydraulic circuit of a conventional hydraulic control apparatus.

FIG. 7 is a schematic view of the hydraulic circuit of the hydraulic control apparatus according to the first embodiment.

FIG. 8 illustrates a schematic configuration of the brake system BS according to a second embodiment together with the hydraulic circuit.

FIG. 9 illustrates an operation of the brake system BS according to the second embodiment when a failure has occurred in a first pump.

FIG. 10 illustrates an operation of the brake system BS according to the second embodiment when a failure has occurred in the second pump.

FIG. 11 illustrates a schematic configuration of the brake system BS according to a third embodiment together with the hydraulic circuit.

FIG. 12 illustrates a schematic configuration of the brake system according to a fourth embodiment together with the hydraulic circuit.

### DESCRIPTION OF EMBODIMENTS

### First Embodiment

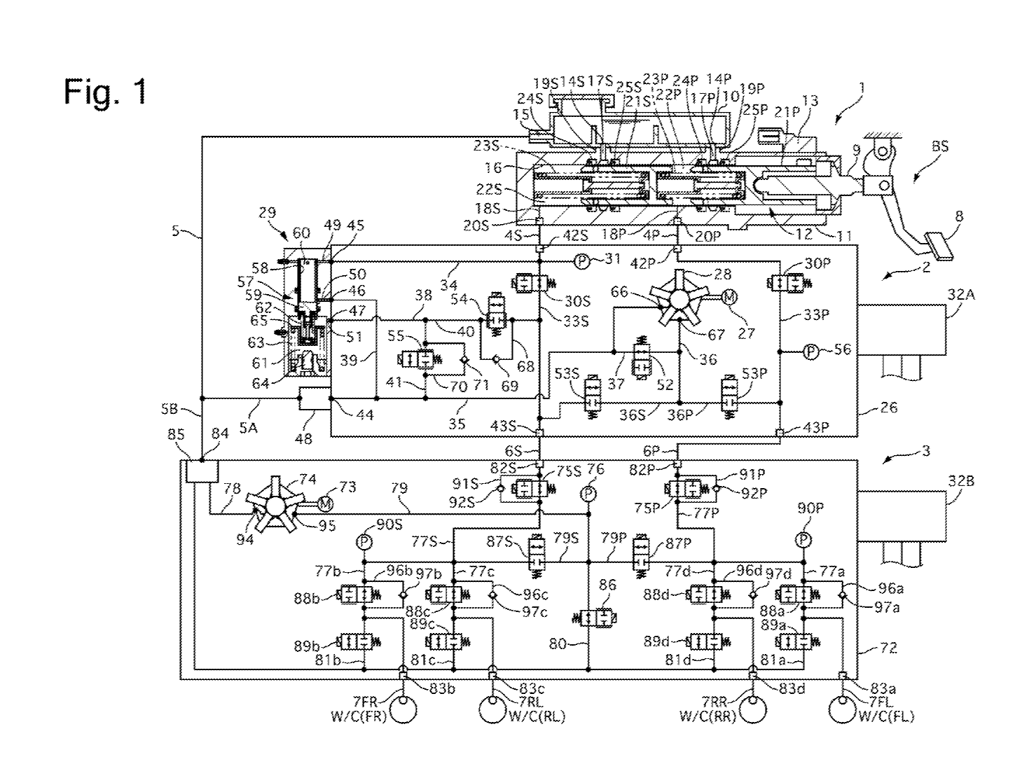

FIG. 1 illustrates a schematic configuration of a brake system BS according to a first embodiment together with a hydraulic circuit. The brake system BS according to the first embodiment is a hydraulic brake system mountable on a hybrid automobile including an electric motor generator in addition to an internal combustion engine, an electric automobile including only the electric motor generator, and the like, besides a vehicle including only the internal combustion engine (an engine) as a prime mover that drives wheels. The brake system BS includes a disk-type brake actuation unit for each of wheels FL to RR. The brake system BS applies a frictional braking force to each of the wheels FL to RR by supplying brake fluid serving as hydraulic fluid to a wheel cylinder W/C of the brake actuation unit and pressing brake pads against a brake disk. The brake system BS includes brake pipes of two systems (a primary P system and a secondary S system). A brake pipe configuration is, for example, an X-split pipe configuration. The brake system BS may employ another pipe configuration, such as a front/rear split pipe configuration. Hereinafter, when a member corresponding to the primary system (the P system) and a member corresponding to the secondary system (the S system) are distinguished from each other, they will be distinguished from each other as appropriate by adding indexes P and S at the ends of the reference numerals thereof, respectively. The brake system BS supplies the brake fluid to each of the wheel cylinders W/C via brake pipes.

The brake system BS includes a master cylinder unit 1, a first hydraulic unit 2, and a second hydraulic unit 3. The first hydraulic unit 2 and the second hydraulic unit 3 are a hydraulic control apparatus that controls a brake hydraulic pressure of each of the wheel cylinders W/C (a wheel cylinder hydraulic pressure). The master cylinder unit 1 and the first hydraulic unit 2 are connected to each other via a first primary pipe (a connection fluid passage and a primary system connection fluid passage) 4P, a first secondary pipe (the connection fluid passage and a secondary system connection fluid passage) 4S, a reservoir pipe (a first intake fluid passage and a second intake fluid passage) 5 and a reservoir pipe (the first intake fluid passage) 5A for the first hydraulic unit 2 which branches off from the reservoir pipe 5. The master cylinder unit 1 and the second hydraulic unit 3 are connected to each other via the reservoir pipe 5 and a reservoir pipe (the second intake fluid passage) 5B for the second hydraulic unit 3 which branches off from the reservoir pipe 5. The brake system BS may be configured in such a manner that the reservoir pipe 5 does not branch and the reservoir pipes 5A and 5B are each directly connected to the master cylinder unit 1. The first hydraulic unit 2 and the second hydraulic unit 3 are connected to each other via a second primary pipe (the connection fluid passage and the primary system connection fluid passage) 6P and a second secondary pipe (the connection fluid passage and the secondary system connection fluid passage) 6S. The second hydraulic unit 3 and each of the wheel cylinders W/C are connected to each other via a wheel cylinder pipe (the connection fluid passage) 7FL, 7FR, 7RL, or 7RR. The wheel cylinder pipes 7FL and 7RR are the primary system connection fluid passage. The wheel cylinder pipes 7FR and 7RL are the secondary system connection fluid passage.

The master cylinder unit 1 includes a brake pedal 8, an input rod 9, a reservoir tank (a reservoir) 10, a master cylinder housing 11, a master cylinder 12, and a stroke sensor 13. The master cylinder unit 1 does not include a booster that boosts a brake operation force by utilizing, for example, an intake negative pressure generated by the engine. The brake pedal 8 receives an input of a brake operation performed by a driver. The input rod 9 is vertically rotatably connected to the brake pedal 8. The reservoir tank 10 stores therein the brake fluid at an atmospheric pressure. The reservoir tank 10 includes replenishment ports 14 and a supply port 15. The supply port 15 is connected to the reservoir pipe 5. The master cylinder housing 11 is a casing that contains (houses) the master cylinder 12 therein. The master cylinder housing 11 includes therein a cylinder 16 for the master cylinder 12, replenishment fluid passages 17, and supply fluid passages 18. One end side of each of the replenishment fluid passages 17 is connected to the cylinder 16. The other end side of each of the replenishment fluid passages 17 is connected to a replenishment port 19 opened on an outer surface of the master cylinder housing 11. The replenishment port 19 is connected to the replenishment port 14 of the reservoir tank 10. One end side of each of the supply fluid passages 18 is connected to the cylinder 16. The other end side of each of the supply fluid passages 18 is connected to a supply port 20 opened on the outer surface of the master cylinder housing 11. A supply port 20P is connected to the primary pipe 4P. A supply port 20S is connected to the secondary pipe 4S.

The master cylinder 12 is connected to the brake pedal 8 via the input rod 9, and generates a master cylinder hydraulic pressure according to the operation performed by the driver on the brake pedal 8. The master cylinder 12 includes pistons 21 axially movable according to the operation on the brake pedal 8. The pistons 21 are contained inside the cylinder 16, and define hydraulic chambers 22. The master cylinder 12 is a tandem-type cylinder, and includes, as the pistons 21, a primary piston 21P pushed by the input rod 9 and a secondary piston 21S configured as a free piston. These pistons 21P and 21S are arranged in series. These pistons 21P and 21S define a primary chamber 22P in the cylinder 16. The secondary piston 21S defines a secondary chamber 22S in the cylinder 16. Each of the hydraulic chambers 22P and 22S is replenished with the brake fluid from the reservoir tank 10, and generates the master cylinder hydraulic pressure by a movement of the above-described piston 21. A coil spring 23P as a return spring is disposed in the primary chamber 22P. The coil spring 23P is disposed between these pistons 21P and 21S. A coil spring 23S as a return spring is disposed in the secondary chamber 22S. The coil spring 23S is disposed between a bottom portion of the cylinder 16 and the piston 21S. Piston seals 24 and 25 are set on an inner periphery of the cylinder 16. The piston seals 24 and 25 are a plurality of seal members that seal between an outer peripheral surface of each of the pistons 21P and 21S and an inner peripheral surface of the cylinder 16 while being in sliding constant with each of the pistons 21P and 21S. Each of the piston seals is a well-known seal member cup-shaped in cross-section that includes a lip portion on an inner diameter side (a cup seal). Each of the piston seals permits a flow of the brake fluid in one direction while restricting a flow of the brake fluid in the other direction with the lip portion in contact with the outer peripheral surface of the piston 21. The first piston seals 24 each permit a flow of the brake fluid directed from the replenishment port 14 toward the primary chamber 22P or the secondary chamber 22S while restricting a flow of the brake fluid in an opposite direction. The second piston seals 25 each permit a flow of the brake fluid directed toward the replenishment port 14 while restricting an outflow of the brake fluid from the replenishment port 14. The stroke sensor 13 detects a movement amount of the primary piston 21P (a pedal stroke amount).

The first hydraulic unit 2 includes a first hydraulic unit housing 26, a first motor 27, a first pump (a first hydraulic source) 28, a stroke simulator unit 29, a plurality of electromagnetic valves 30 and the like, a plurality of hydraulic sensors 31 and the like, and a first electronic control unit (a control unit) 32A. The first unit housing 26 is a casing that contains (houses) the first pump 28 and valve bodies of the plurality of electromagnetic valves 30 and the like therein. The first hydraulic unit housing 26 includes therein circuits of the above-described two systems (the P system and the S system) through which the brake fluid flows. The circuits of the two systems include a plurality of fluid passages. The plurality of fluid passages includes first connection fluid passages 33, a stroke simulator fluid passage 34, a first intake fluid passage 35, a first discharge fluid passage 36, a first return flow fluid passage 37, a back-pressure fluid passage 38, a replenishment fluid passage 39, a first simulator fluid passage 40, and a second simulator fluid passage 41. Further, the first hydraulic unit housing 26 includes a plurality of ports. The plurality of ports includes first input ports 42, first output ports 43, a first reservoir connection port 44, a simulator connection port 45, a replenishment port 46, and a back-pressure port 47. The first input port 42P is connected to the first primary pipe 4P. The first input port 42S is connected to the first secondary pipe 4S. The first output port 43P is connected to the second primary pipe 6P. The first output port 43S is connected to the second secondary pipe 6S. The first reservoir connection port 44 is connected to the reservoir pipe 5A via a sub tank 48, which is a fluid pool. The simulator connection port 45 is connected to a simulator connection fluid passage 49 of the stroke simulator unit 29. The replenishment port 46 is connected to a replenishment fluid passage 50 of the stroke simulator unit 29. The back-pressure port 47 is connected to a back-pressure fluid passage 51 of the stroke simulator unit 29. The first pump 28 introduces the brake fluid in the reservoir tank 10, and discharges this brake fluid. In the first embodiment, a plunger pump including five plungers, which is excellent in terms of, for example, a noise and vibration performance, is employed as the first pump 28. The first motor 27 drives the first pump 28. The plurality of electromagnetic valves 30 and the like are each a solenoid valve that operates according to a control signal. The plurality of electromagnetic valves 30 and the like each switch opening/closing of the fluid passage (establish or block communication through the fluid passage) due to a stroke of the valve body thereof according to power supply to the solenoid. The plurality of electromagnetic valves 30 and the like each generate a control hydraulic pressure by controlling a communication state of the above-described circuit to adjust a flow state of the brake fluid. The plurality of electromagnetic valves 30 and the like include first shut-off valves 30, a first pressure adjustment valve 52, first communication valves 53, a stroke simulator IN valve 54, and a stroke simulator OUT valve 55. The first shut-off valves 30 and the first pressure adjustment valve 52 are each a normally opened proportional control valve opened when no power is supplied thereto. The first communication valves 53, the stroke simulator IN valve 54, and the stroke simulator OUT valve 55 are each a normally closed ON/OFF valve closed when no power is supplied thereto. In FIG. 1, the plurality of electromagnetic valves 30 and the like are in the state that no power is supplied thereto. The plurality of hydraulic sensors 31 and the like include a master cylinder hydraulic sensor 31 and a first discharge pressure sensor 56.

The stroke simulator unit 29 includes the stroke simulator 57, the simulator connection port 45, and the simulator connection fluid passage 49. The stroke simulator 57 provides a reaction force and a stroke to the brake pedal 8 according to the brake operation performed by the driver. The stroke simulator 57 includes a cylinder 58, a piston 59, a positive pressure chamber 60, a back-pressure chamber 61, and elastic members (a first spring 62, a second spring 63, and a damper 64). The piston 59, the positive pressure chamber 60, the back-pressure chamber 61, and the elastic members are disposed inside the cylinder 58. The piston 59 divides the inside of the cylinder 58 into the positive pressure chamber 60 and the back-pressure chamber 61. The elastic members bias the piston 59 in a direction for reducing a volume of the positive pressure chamber 60. A bottomed cylindrical retainer member 65 is disposed between the first spring 62 and the second spring 63. The positive pressure chamber 60 is connected to the simulator connection fluid passage 49. The back-pressure chamber 61 is connected to the back-pressure port 47. When the back-pressure chamber 61 has a negative pressure therein, the back-pressure chamber 61 is in communication with the replenishment port 46. When the brake fluid flows from the secondary chamber 22S of the master cylinder 12 into the positive pressure chamber 60 according to the brake operation performed by the driver, the pedal stroke is generated, and at the same time, the reaction force of the brake operation performed by the driver is generated due to the biasing forces of the elastic members.

The first electronic control unit 32A receives inputs of detection values of the stroke sensor 13 and the plurality of hydraulic sensors 31 and the like, information regarding a running state from the vehicle side, and information from the second hydraulic unit 3. The first electronic control unit 32A controls opening/closing operations of the plurality of electromagnetic valves 30 and the like and the number of rotations of the first motor 27 (i.e., a discharge flow rate of the first pump 28) with use of each of the input detection values and pieces of the information, based on a program built therein.

In the following description, the brake hydraulic circuit of the first hydraulic unit 2 will be described.

One end sides of the first connection fluid passages 33 are connected to the first input ports 42. The other end sides of the first connection fluid passages 33 are connected to the first output ports 43. The first shut-off valves 30 are disposed in the first connection fluid passages 33. The master cylinder hydraulic sensor 31 is disposed at a position in the first connection fluid passage (the secondary system connection fluid passage) 33S on one side where the first input ports 42 are located with respect to the first shut-off valve 30S. Further, one end side of the stroke simulator fluid passage 34 is connected to this position. The other end side of the stroke simulator fluid passage 34 is connected to the simulator connection port 45. The master cylinder hydraulic sensor 31 detects the master cylinder hydraulic pressure. The first discharge pressure sensor 56 is disposed at a position in the first connection fluid passage (the primary system connection fluid passage) 33P on the first output port 43P side with respect to the first shut-off valve 30P. The first discharge pressure sensor 56 detects the discharge pressure of the first pump 28. One end side of the first intake fluid passage 35 is connected to the first reservoir connection port 44. The other end side of the first intake fluid passage 35 is connected to a first intake port 66 of the first pump 28. One end side of the first discharge fluid passage 36 is connected to a first discharge port 67 of the first pump 28. The other end side of the first discharge fluid passage 36 branches off into a discharge fluid passage 36P of the P system and a discharge fluid passage 36S of the S system. These discharge fluid passages 36P and 36S are connected to positions in the first connection fluid passages 33 on the first output ports 43 side with respect to the first shut-off valves 30. These discharge fluid passages 36P and 36S according to the first embodiment are the first communication fluid passage connecting the first connection fluid passage 33P of the P system and the first connection fluid passage 33S of the S system to each other, and connected to the first discharge fluid passage 36. The first communication valves 53P and 53S are disposed in these discharge fluid passages 36P and 36S, respectively. The first communication valve 53P is a primary system first communication valve. The first communication valve 53S is a secondary system first communication valve. One end side of the first return flow fluid passage 37 is connected to the first intake fluid passage 35. The other end side of the first return flow fluid passage 37 is connected to the first discharge fluid passage 36. The first pressure adjustment valve 52 is disposed in the first return flow fluid passage 37. The back-pressure fluid passage 38 is connected to the back-pressure port 47. One end side of the replenishment fluid passage 39 is connected to the replenishment port 46. The other end side of the replenishment fluid passage 39 is connected to the first intake fluid passage 35. One end side of the first simulator fluid passage 40 is connected to the back-pressure fluid passage 38. The other end side of the first simulator fluid passage 40 is connected to a position in the first connection fluid passage 33S on the first output ports 43 side with respect to the first shut-off valve 30S and on the first input ports 42S side with respect to a position at which the first connection fluid passage 33S is connected to the discharge fluid passage 36S. The stroke simulator IN valve 54 is provided in the first simulator fluid passage 40. A bypass fluid passage 68 is provided in parallel with the first simulator fluid passage 40 while bypassing the stroke simulator valve IN 54. A check valve 69 is provided in the bypass fluid passage 68. The check valve 69 permits only a flow of the brake fluid directed from the back-pressure fluid passage 38 side toward the first connection fluid passage 33S side. One end side of the second simulator fluid passage 41 is connected to the back-pressure fluid passage 38. The other end side of the second simulator fluid passage 41 is connected to a position on the first intake port 66 side with respect to a position at which the first intake fluid passage 35 is connected to the replenishment fluid passage 39. The stroke simulator OUT valve 55 is provided in the second simulator fluid passage 41. A bypass fluid passage 70 is provided in parallel with the second simulator fluid passage 41 while bypassing the stroke simulator OUT valve 55. A check valve 71 is provided in the bypass fluid passage 70. The check valve 71 permits only a flow of the brake fluid directed from the first intake fluid passage 35 side toward the back-pressure fluid passage 38 side.

The second hydraulic unit 3 includes a second hydraulic unit housing 72, a second motor 73, a second pump (a second hydraulic source) 74, a plurality of electromagnetic valves 75 and the like, a plurality of hydraulic sensors 76 and the like, and a second electronic control unit (a control unit) 32B. Hereinafter, when a member corresponding to each of the wheels FL to RR is distinguished from one another, they will be distinguished from one another as appropriate by adding indexes a to d at the ends of the reference numerals thereof, respectively. The second hydraulic unit housing 72 is a casing that contains (houses) the second pump 74 and valve bodies of the plurality of electromagnetic valves 75 and the like therein. The second hydraulic unit housing 72 includes therein circuits of the above-described two systems (the P system and the S system) through which the brake fluid flows. The circuits of the two systems include a plurality of fluid passages. The plurality of fluid passages includes second connection fluid passages 77, a second intake fluid passage 78, a second discharge fluid passage 79, a second return flow fluid passage 80, and pressure reduction fluid passages 81. Further, the second hydraulic unit housing 72 includes a plurality of ports. The plurality of ports are second input ports 82, second output ports 83, and a second reservoir connection port 84. The second input port 82P is connected to the second primary pipe 6P. The second input port 82S is connected to the second secondary pipe 6S. The second output ports 83 are connected to the wheel cylinders W/C. The second reservoir connection port 84 is connected to the reservoir pipe 5B. An internal reservoir 85, which is a fluid pool, is connected to the second reservoir connection port 84. The second pump 74 introduces the brake fluid in the reservoir tank 10, and discharges this brake fluid. The second pump 74 is a plunger pump similar to the first pump 28. The second motor 73 drives the second pump 74. The plurality of electromagnetic valves 75 and the like are each a solenoid valve that operates according to a control signal. The plurality of electromagnetic valves 75 and the like each switch opening/closing of the fluid passage due to a stroke of the valve body thereof according to power supply to the solenoid. The plurality of electromagnetic valves 75 and the like each generate a control hydraulic pressure by controlling a communication state of the above-described circuit to adjust a flow state of the brake fluid. The plurality of electromagnetic valves 75 and the like include the second shut-off valves 75, a second pressure adjustment valve 86, second communication valves 87, solenoid IN valves 88, and solenoid OUT valves 89. The second shut-off valves 75, the second pressure adjustment valve 86, and the solenoid IN valves 88 are each a normally opened proportional control valve opened when no power is supplied thereto. The second communication valves 87 and the solenoid OUT valves 89 are each a normally closed ON/OFF valve closed when no power is supplied thereto. In FIG. 1, the plurality of electromagnetic valves 75 and the like are in the state that no power is supplied thereto. The plurality of hydraulic sensors 76 and the like include the second discharge pressure sensor 76 and wheel cylinder hydraulic sensors 90.

The second electronic control unit 32B receives inputs of detection values of the stroke sensor 13 and the plurality of hydraulic sensors 76 and the like, the information regarding the running state from the vehicle side, and information from the first hydraulic unit 2. The second electronic control unit 32B controls opening/closing operations of the plurality of electromagnetic valves 75 and the like and the number of rotations of the second motor 73 (i.e., a discharge flow rate of the second pump 74) with use of each of the input detection values and pieces of the information, based on a program built therein.

In the following description, the brake hydraulic circuit of the second hydraulic unit 3 will be described.

One end sides of the second connection fluid passages 77 are connected to the second input ports 82. The other end side of the second connection fluid passage (the primary system connection fluid passage) 77P branches off into the second connection fluid passage 77a and the second connection fluid passage 77d. The other end side of the second connection fluid passage (the secondary system connection fluid passage) 77S branches off into the second connection fluid passage 77b and the second connection fluid passage 77c. The second connection fluid passages 77a to 77d are connected to the second output ports 83a to 83d, respectively. The second shut-off valve 75 is provided in each of the second connection fluid passages 77. A bypass fluid passage 91 is provided in parallel with the second connection fluid passage 77 while bypassing the second shut-off valve 75. A check valve 92 is provided in the bypass fluid passage 91. The check valve 92 permits only a flow of the brake fluid directed from the second input ports 82 side toward the second output ports 83 side. The solenoid IN valve 88a and the solenoid IN valve 88d are provided in the second connection fluid passage 77a and the second connection fluid passage 77d, respectively. A bypass fluid passage 96a and a bypass fluid passage 96d are provided in parallel with the second connection fluid passage 77a and the second connection fluid passage 77d while bypassing the solenoid IN valve 88a and the solenoid IN valve 88d, respectively. A check valve 97a and a check valve 97d are provided in the bypass fluid passage 96a and the bypass fluid passage 96d, respectively. The check valve 97a and the check valve 97d permit only a flow of the brake fluid directed from the second output ports 83 side toward the second input ports 82 side. The solenoid IN valve 88b and the solenoid IN valve 88c are provided in the second connection fluid passage 77b and the second connection fluid passage 77c, respectively. A bypass fluid passage 96b and a bypass fluid passage 96c are provided in parallel with the second connection fluid passage 77b and the second connection fluid passage 77c while bypassing the solenoid IN valve 88b and the solenoid IN valve 88c, respectively. A check valve 97b and a check valve 97c are provided in the bypass fluid passage 96b and the bypass fluid passage 96c, respectively. The check valve 97b and the check valve 97c permit only a flow of the brake fluid directed from the second output ports 83 side toward the second input ports 82 side.

One end side of the second intake fluid passage 78 is connected to the internal reservoir 85 (the second reservoir connection port 84). The other end side of the second intake fluid passage 78 is connected to a second intake port 94 of the second pump 74. One end side of the second discharge fluid passage 79 is connected to a second discharge port 95 of the second pump 74. The second discharge pressure sensor 76 is provided in the second discharge fluid passage 79. The second discharge pressure sensor 76 detects a discharge pressure of the second pump 74. The other end side of the second discharge fluid passage 79 branches off into a discharge fluid passage (a second communication fluid passage and a primary system second discharge fluid passage) 79P of the P system and a discharge fluid passage (the second communication fluid passage and a secondary system second discharge fluid passage) 79S of the S system. These discharge fluid passages 79P and 79S are connected to positions in the second connection fluid passages 77 on the second output ports 83 side with respect to the second shut-off valves 75. These discharge fluid passages 79P and 79S according to the first embodiment are the first communication fluid passage connecting the second connection fluid passage 77P of the P system and the second connection fluid passage 77S of the S system to each other, and connected to the second discharge fluid passage 79. The second communication valves 87P and 87S are provided in these discharge fluid passages 79P and 79S, respectively. The second communication valve 87P is the primary system second communication value. The second communication valve 87S is the secondary system second communication value. One end side of the second return flow fluid passage 80 is connected to a position at which the second discharge fluid passage 79 and these discharge fluid passages 79P and 79S are connected to each other. The other end side of the second return flow fluid passage 80 is connected to the internal reservoir 85 (the second reservoir connection port 84). The second pressure adjustment valve 86 is provided in the second return flow fluid passage 80. One end side of each of the pressure reduction fluid passages 81 is connected to a position in the second connection fluid passages 77 on the second output ports 83 side with respect to the solenoid IN valves 88. The other end side of each of the pressure reduction fluid passages 81 is connected to the second return flow fluid passage 80. The solenoid OUT valves 89 are provided in the pressure reduction fluid passages 81.

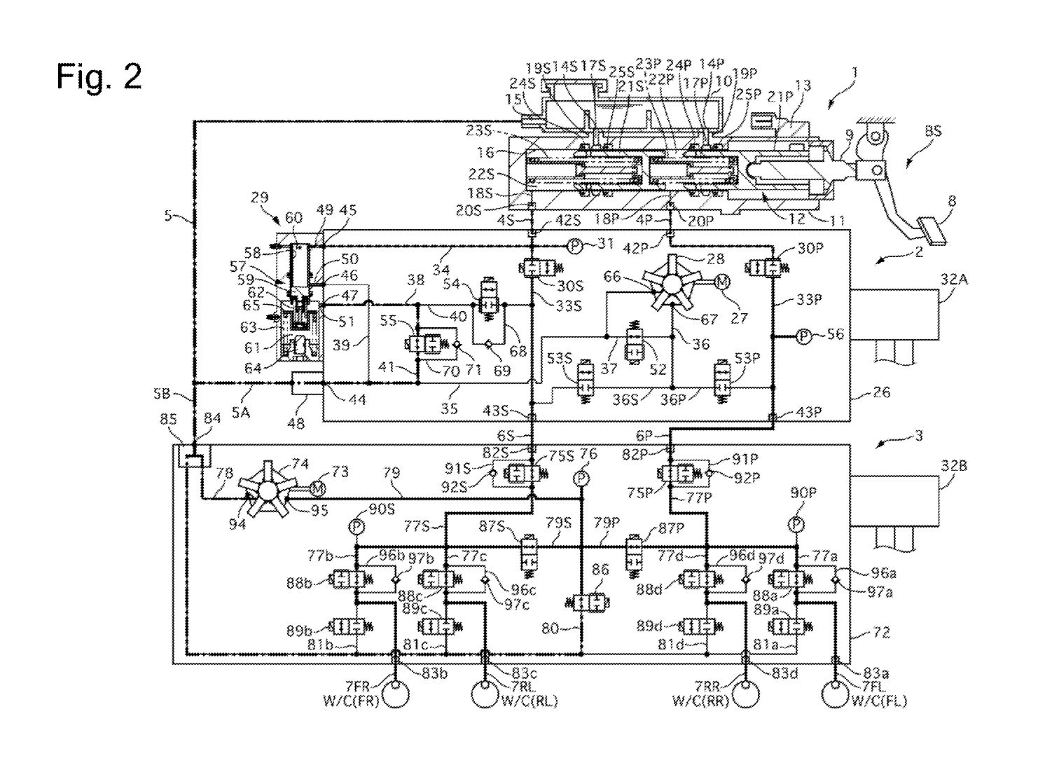

FIG. 2 illustrates an operation of the brake system BS at the time of normal braking that generates the braking force according to the brake operation performed by the driver. A region indicated by a thick line represents a region having a pressure equal to the wheel cylinder hydraulic pressure. A region indicated by a broken line represents a region having a pressure equal to the master cylinder hydraulic pressure. A region indicated by an alternate long and short dash line represents a region having a pressure equal to the brake hydraulic pressure in the reservoir tank 10 (the atmospheric pressure). The same also applies to the other drawings.

The master cylinder unit 1 according to the first embodiment does not include a booster that boosts the brake operation force input by the driver. Therefore, the brake system BS performs the following boosting control when the brake operation is performed by the driver.

The first electronic control unit 32A controls the first shut-off valves 30 in valve-closing directions, thereby shutting off the flow of the brake fluid between the master cylinder 12 and the first hydraulic unit 2. Further, the first electric control unit 32A controls the stroke simulator OUT valve 55 in a valve-opening direction, thereby causing the stroke simulator 57 to function.

The second electronic control unit 32B controls the second communication valves 87 in valve-opening directions, thereby establishing the communication between the second connection fluid passage 77P of the P system and the second connection fluid passage 77S of the S system. The second electric control unit 32B calculates a target wheel cylinder hydraulic pressure for acquiring a predetermined boosting ratio based on the pedal stroke amount detected by the stroke sensor 13, and calculates a target upstream hydraulic pressure for realizing the target wheel cylinder hydraulic pressure. The second electric control unit 32B causes the second pump 74 to operate at a predetermined number of rotations, and controls the second pressure adjustment valve 86 in a valve-closing direction in such a manner that an upstream hydraulic pressure of the second pressure adjustment valve 86 detected by the first discharge pressure sensor 56 matches the target upstream hydraulic pressure.

Due to this operation, the brake system BS can acquire a vehicle deceleration according to a driver's request while reducing a required brake operation force of the driver.

At the time of sudden braking in which a change amount of the pedal stroke per unit time reaches or exceeds a predetermined sudden braking threshold value, the first electric control unit 32A controls the stroke simulator IN valve 54 in a valve-opening direction and controls the stroke simulator OUT valve 55 in the valve-closing direction. Due to this control, the brake system BS can secure responsiveness in terms of a rise of the wheel cylinder hydraulic pressures with use of the brake fluid flowing out of the back-pressure chamber 61 of the stroke simulator 57 since the driver starts the brake operation until the second pump 74 is ready to generate sufficiently high wheel cylinder hydraulic pressures. When the change amount of the pedal stroke per unit time falls below the sudden braking threshold value, the first electric control unit 32A controls the stroke simulator IN valve 54 in a valve-closing direction and controls the stroke simulator OUT valve 55 in a valve-opening direction.

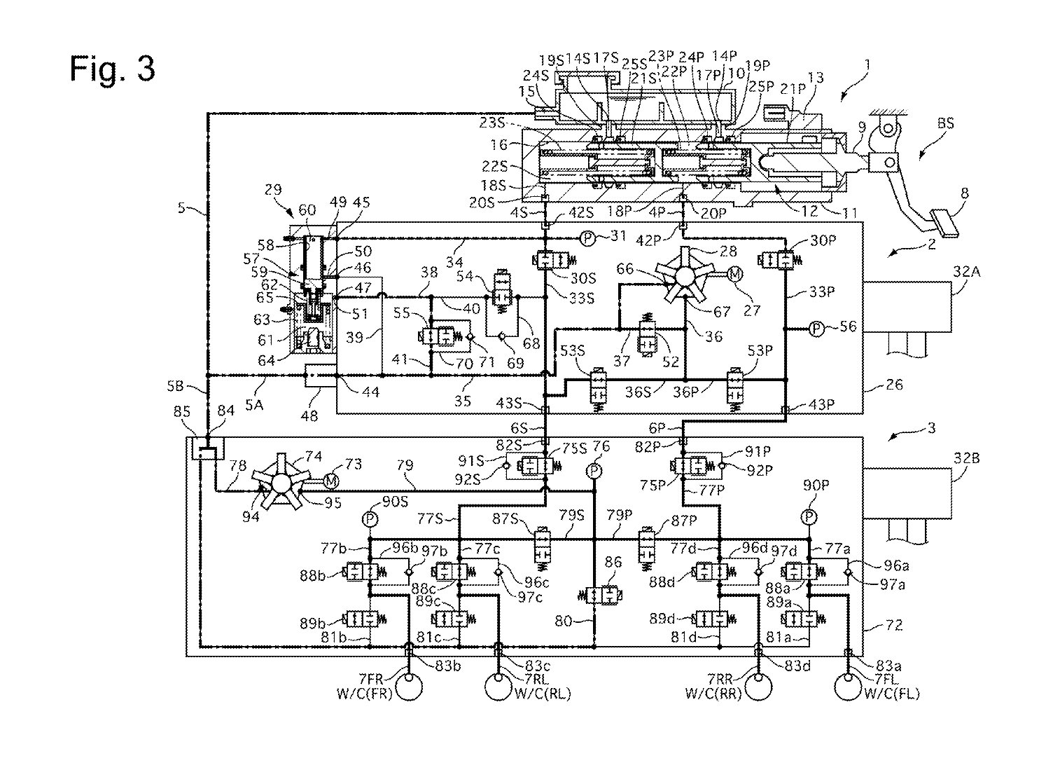

FIG. 3 illustrates an operation of the brake system BS at the time of autonomous application of emergency braking (AEB: Autonomous Emergency Braking). When the brake system BS detects an obstacle present in a direction in which the vehicle is traveling and the vehicle approaches this obstacle, the brake system BS performs the following autonomous emergency braking, thereby suddenly slowing down the vehicle.

The first electronic control unit 32A controls the first shut-off valves 30 in the valve-closing directions and controls the stroke simulator OUT valve 55 in the valve-opening direction. The first electronic control unit 32A controls the first communication valves 53 in valve-opening directions, thereby establishing the communication between the first connection fluid passage 33P of the P system and the first connection fluid passage 33S of the S system. The first electric control unit 32A causes the first pump 28 to operate at a predetermined number of rotations (for example, a maximum number of rotations), and controls the first pressure adjustment valve 52 in a valve-closing direction in such a manner that an upstream hydraulic pressure of the first pressure adjustment valve 52 detected by the first discharge pressure sensor 56 matches the target upstream hydraulic pressure calculated by the second electronic control unit 32B.

The second electronic control unit 32B controls the second communication valves 87 in the valve-opening directions, and causes the second pump 74 to operate at a predetermined number of rotations. The second electronic control unit 32B calculates a target wheel cylinder hydraulic pressure for avoiding a contact with the obstacle or reducing damage from the contact, and calculates a target upstream hydraulic pressure for realizing the target wheel cylinder hydraulic pressure. The second electronic control unit 32B causes the second pump 74 to operate at a predetermined number of rotations (for example, a maximum number of rotations), and controls the second pressure adjustment valve 86 in the valve-closing direction in such a manner that the upstream hydraulic pressure of the second pressure adjustment valve 86 detected by the first discharge pressure sensor 56 matches the target upstream hydraulic pressure.

In the autonomous emergency braking, the brake system BS should generate a greater braking force in a short time than the braking force at the time of the normal braking. Therefore, the pressures in the wheel cylinders W/C should be increased with high responsiveness. In the autonomous emergency braking control according to the first embodiment, the brake system BS actuates both the first pump 28 and the second pump 74 to increase the pressures in the wheel cylinders W/C, thereby succeeding in securing the responsiveness in terms of increasing the pressures in the wheel cylinders W/C that is necessary for the autonomous emergency braking. The operation of the autonomous emergency braking may be performed at the time of the sudden braking.

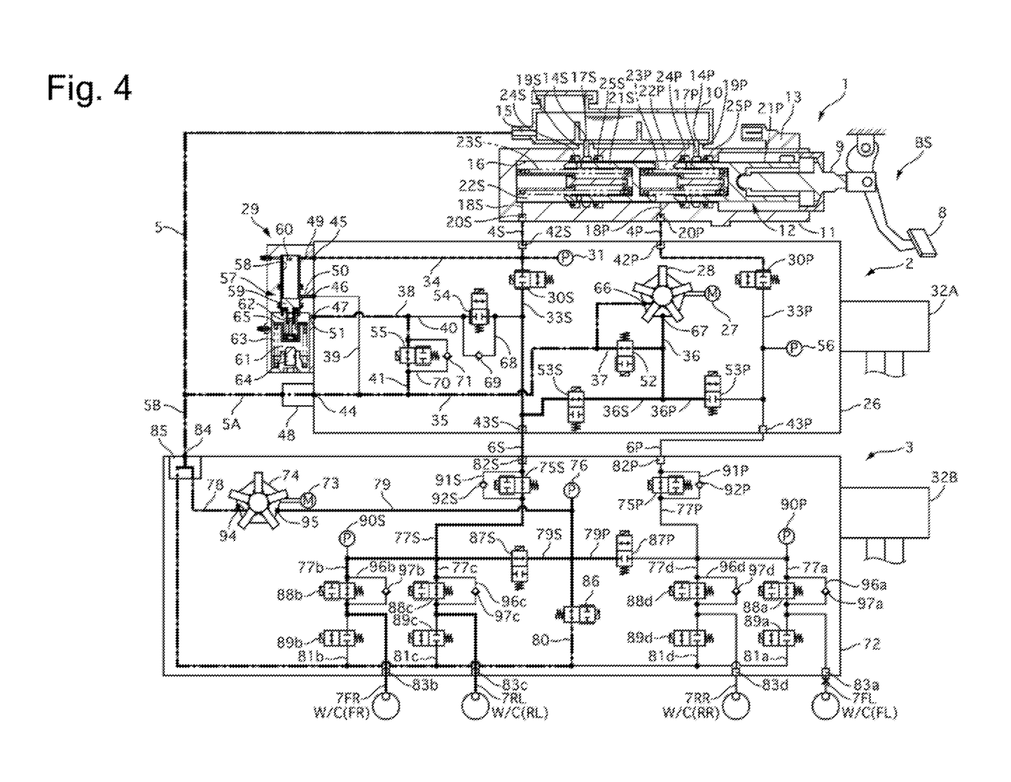

FIG. 4 illustrates an operation of the brake system BS when a fluid leak failure has occurred in the P system, and illustrates the brake system BS with a fluid leak occurred from the wheel cylinder pipe 7FL connecting the second hydraulic unit 3 and the wheel cylinder W/C (FL) of the front left wheel FL to each other while the vehicle is running. When a difference equal to or greater than a predetermined value is generated between the detection value of the wheel cylinder hydraulic sensor 90P of the P system and the detection value of the wheel cylinder hydraulic sensor 90S of the S system with the first communication valves 53 and the second communication valves 87 controlled in the valve-closing directions while the wheel cylinder hydraulic pressures are kept constant during the normal braking, the brake system BS determines that a fluid leak has occurred in the system having a low detection value. If determining that a fluid leak has occurred in the P system, the brake system BS performs boosting control designed to be employed when a fluid leak failure has occurred in the P system, which will be described now.

The first electronic control unit 32A controls the first shut-off valves 30 in the valve-closing directions and controls the stroke simulator OUT valve 55 in the valve-opening direction. The first electronic control unit 32A controls the first communication valve 53S of the S system in the valve-opening direction and maintains the first communication valve 53P of the P system in a valve-closed state, thereby blocking the flow of the brake fluid between the first connection fluid passage 33P of the P system and the first connection fluid passage 33S of the S system. The first electronic control unit 32A controls the first pressure adjustment valve 52 in the valve-closing direction in such a manner that the upstream hydraulic pressure of the first pressure adjustment valve 52 detected by the second discharge pressure sensor 76 matches the target upstream hydraulic pressure calculated by the second electronic control unit 32B.

The second electronic control unit 32B controls the second communication valve 87S of the S system in the valve-opening direction and maintains the second communication valve 87P of the P system in a valve-closed state, thereby blocking the flow of the brake fluid between the second connection fluid passage 77P of the P system and the second connection fluid passage 77S of the S system. The second electric control unit 32B calculates the target wheel cylinder hydraulic pressure for acquiring a predetermined deceleration based on the pedal stroke amount detected by the stroke sensor 13, and calculates the target upstream hydraulic pressure for realizing the target wheel cylinder hydraulic pressure. The second electronic control unit 32B causes the second pump 74 to operate at a predetermined number of rotations, and controls the second pressure adjustment valve 86 in the valve-closing direction in such a manner that the upstream hydraulic pressure of the second pressure adjustment valve 86 detected by the second discharge pressure sensor 76 matches the target upstream hydraulic pressure.

Due to this operation, the brake system BS can continue the boosting control while preventing or cutting down a reduction in the fluid amount in the reservoir.

An operation of the brake system BS when a failure has occurred in the first pump is the same as the operation at the time of the normal braking illustrated in FIG. 2. The first pump 28 is not actuated at the time of the normal braking, and therefore the brake system BS can continue the boosting control without a problem even when a failure has occurred in the first pump 28.

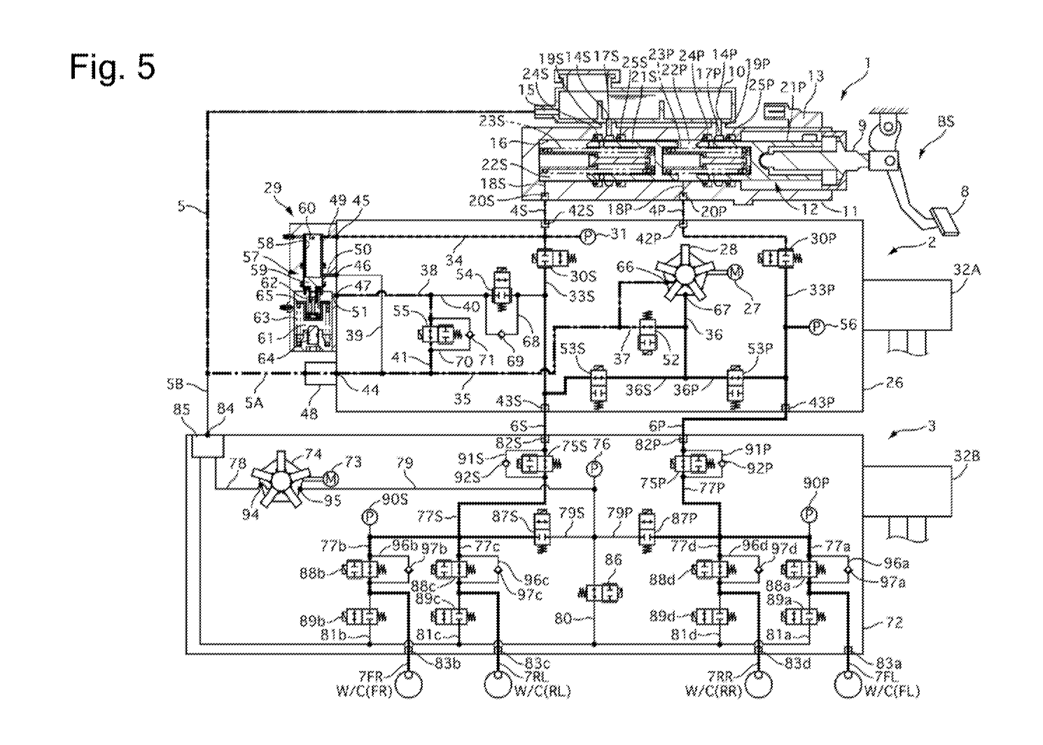

FIG. 5 illustrates an operation of the brake system BS when a failure has occurred in the second pump. If a failure has occurred in the second pump 74 while the vehicle is running, the brake system BS performs boosting control designed to be employed when a failure has occurred in the second pump, which will be described now.

The first electronic control unit 32A controls the first shut-off valves 30 in the valve-closing directions and controls the stroke simulator OUT valve 55 in the valve-opening direction. The first electronic control unit 32A controls the first communication valves 53 in the valve-opening directions, thereby establishing the communication between the first connection fluid passage 33P of the P system and the first connection fluid passage 33S of the S system. The first electronic control unit 32A controls the first pressure adjustment valve 52 in the valve-closing direction in such a manner that the upstream hydraulic pressure of the first pressure adjustment valve 52 detected by the first discharge pressure sensor 56 matches the target upstream hydraulic pressure calculated by the second electronic control unit 32B.

The second electric control unit 32B calculates the target wheel cylinder hydraulic pressure for acquiring a predetermined deceleration based on the pedal stroke amount detected by the stroke sensor 13, and calculates the target upstream hydraulic pressure for realizing the target wheel cylinder hydraulic pressure. The second electronic control unit 32B keeps the plurality of electromagnetic valves 75 and the like non-operating state.

Due to this operation, the brake system BS can continue the boosting control even when a failure has occurred in the second motor 73.

Next, functions and effects will be described.

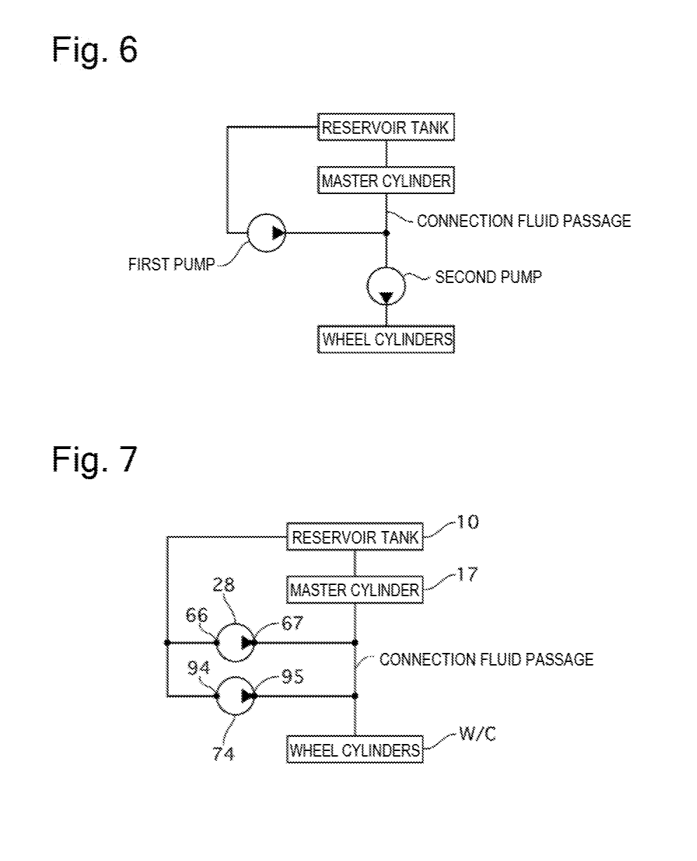

FIG. 6 is a schematic view of a hydraulic circuit of a conventional hydraulic control circuit including redundantly configured pumps for increasing the pressure of the brake fluid. A second pump is disposed in a connection fluid passage connecting a master cylinder and wheel cylinders to each other. A first pump discharges the brake fluid to a portion of the connection fluid passage between the master cylinder and the second pump. The second pump is actuated when a failure has occurred in the first pump, and assists the braking of the wheel. Now, while no master cylinder and no pump are disposed in a fluid passage of the brake fluid from the reservoir tank to the first pump, the master cylinder and the first pump are disposed in a fluid passage (the connection fluid passage) of the brake fluid from the reservoir tank to the second pump. Therefore, the second pump is subject to high resistance against the intake of the brake fluid compared to the first pump. Therefore, the conventional hydraulic control circuit involves a problem of a reduction in the responsiveness in terms of increasing the pressures in the wheel cylinders that is necessary in a scene where the second pump is actuated, such as when a failure has occurred in the first pump or at the time of the autonomous emergency brake. The reduction in the responsiveness is not preferable from the viewpoint of reliability.

On the other hand, in the hydraulic control apparatus (the first hydraulic unit 2 and the second hydraulic unit 3) according to the first embodiment, the first pump 28 is disposed in the fluid passage (the reservoir pipes 5 and 5A, the first intake fluid passage 35, and the first discharge fluid passage 36) connecting the reservoir tank 10 and the first connection fluid passage 33 to each other while bypassing the master cylinder 12. The first intake port 66 of the first pump 28 is connected to the first intake fluid passage 35. The first discharge port 67 of the first pump 28 is connected to the first discharge fluid passage 36. The second pump 74 is disposed in the fluid passage (the reservoir pipes 5 and 5B, the second intake fluid passage 78, and the second discharge fluid passage 79) connecting the reservoir tank 10 and the second connection fluid passage 77 to each other while bypassing the master cylinder 12. The second intake port 94 of the second pump 74 is connected to the second intake fluid passage 78. The second discharge port 95 of the second pump 74 is connected to the second discharge fluid passage 79. In other words, in the hydraulic control apparatus according to the first embodiment, the first discharge port 67 and the second discharge port 95 of the first pump 28 and the second pump 74 are connected to the connection fluid passage connected to the wheel cylinders W/C as illustrated in a schematic view of FIG. 7. Further, the first intake port 66 and the second intake port 94 of the first pump 28 and the second pump 74 are connected to the reservoir tank 10. In other words, in the hydraulic control apparatus according to the first embodiment, the first pump 28 and the second pump 74 are connected in parallel with each other to the connection fluid passage connected to the wheel cylinders W/C. In other words, the first pump 28 and the second pump 74 introduces the brake fluid from the reservoir tank 10 and discharges the brake fluid to the connection fluid passage independently of each other. Therefore, the master cylinder 12 and another pump are not disposed in both the fluid passages of the brake fluid from the reservoir tank 10 to the first pump 28 and the second pump 74, respectively. Therefore, intake resistance of the first pump 28 and the second pump 74 is lower than the intake resistance of the second pump in the conventional hydraulic control apparatus. Therefore, the hydraulic control apparatus according to the first embodiment can improve the responsiveness in terms of increasing the pressures in the wheel cylinders W/C in each mode of brake control. As a result, reliability of the hydraulic control apparatus and the brake system BS can be improved.

The first hydraulic unit 2 includes the first return flow fluid passage 37 connecting the first discharge port 67 and the first intake port 66 of the first pump 28 to each other. The first pressure adjustment valve 52, which adjusts the hydraulic pressures in the wheel cylinders W/C by adjusting the flow rate of the brake fluid passing through the first return flow fluid passage 37, is disposed in the first return flow fluid passage 37. The second hydraulic unit 3 includes the second return flow fluid passage 80 connecting the second discharge port 95 and the second intake port 94 of the second pump 74 to each other. The second pressure adjustment valve 86, which adjusts the hydraulic pressures in the wheel cylinders W/C by adjusting the flow rate of the brake fluid passing through the second return flow fluid passage 80, is disposed in the second return flow fluid passage 80. Therefore, the hydraulic control apparatus according to the first embodiment can realize the boosting control by keeping the first pump 28 non-operating state and actuating only the second pump 74 at the time of the normal braking. On the other hand, the hydraulic control apparatus according to the first embodiment can secure the responsiveness in terms of increasing the pressures in the wheel cylinders W/C that is necessary at the time of the sudden braking by actuating both the first pump 28 and the second pump 74 at the time of the autonomous emergency braking.

The first hydraulic unit 2 includes the discharge fluid passages 36P and 36S as the first communication fluid passage connecting the first connection fluid passage 33P of the P system and the first connection fluid passage 33S of the S system to each other. The first communication valves 53P and 53S are disposed in the discharge fluid passages 36P and 36S, respectively. The second hydraulic unit 3 includes the discharge hydraulic passages 79P and 79S as the second communication fluid passage connecting the second connection fluid passage 77P of the P system and the second connection fluid passage 77S of the S system to each other. The second communication valves 87P and 87S are disposed in the discharge fluid passages 79P and 79S, respectively. When the brake fluid leaks from the wheel cylinder W/C (FL) or W/C (RR) of the P system, the first electronic control unit 32A closes the first communication valve 53P, and the second electronic control unit 32B closes the second communication valve 87P. On the other hand, when the brake fluid leaks from the wheel cylinder W/C (FR) or W/C (RL) of the S system, the first electronic control unit 32A closes the first communication valve 53S, and the second electronic control unit 32B closes the second communication valve 87S. Due to this operation, when a fluid leak failure has occurred in one of the systems, the hydraulic control apparatus according to the first embodiment can continue the boosting control by only the other of the systems. Further, when a failure has occurred in the first pump 28, the first electronic control unit 32A closes the first communication valves 53P and 53S. On the other hand, when a failure has occurred in the second pump 74, the second electronic control unit 32B shuts off the second communication valves 87P and 87S. Due to this operation, when a failure has occurred in one of the pumps, the hydraulic control apparatus according to the first embodiment can continue the boosting control by actuating the other of the pumps.

In the first hydraulic unit 2, the first shut-off valves 30 are respectively disposed at the positions in the first connection fluid passages 33 between the master cylinder 12 and the position at which the discharge fluid passages 36P and 36S are connected to the first connection fluid passages 33. In the second hydraulic unit 3, the second shut-off valves 75 are disposed at the positions on the second input ports 82 side with respect to the positions at which the second connection fluid passages 77 are connected to the discharge fluid passages 79P and 79S, respectively. Due to this configuration, the hydraulic control apparatus according to the first embodiment can block the flow of the brake fluid between the master cylinder 12 and the first hydraulic unit 2, and the flow of the brake fluid between the first hydraulic unit 2 and the second hydraulic unit 3. Therefore, the hydraulic control apparatus according to the first embodiment can realize the boosting control using one or both of the first pump 28 and the second pump 74.

In the first embodiment, the stroke simulator 29 is provided on the first hydraulic unit 2 side, which contributes to a reduction in a size of the second hydraulic unit 3 side.

### Second Embodiment

Next, a second embodiment will be described. The second embodiment is configured basically similarly to the first embodiment, and therefor will be described focusing on only different configurations from the first embodiment.

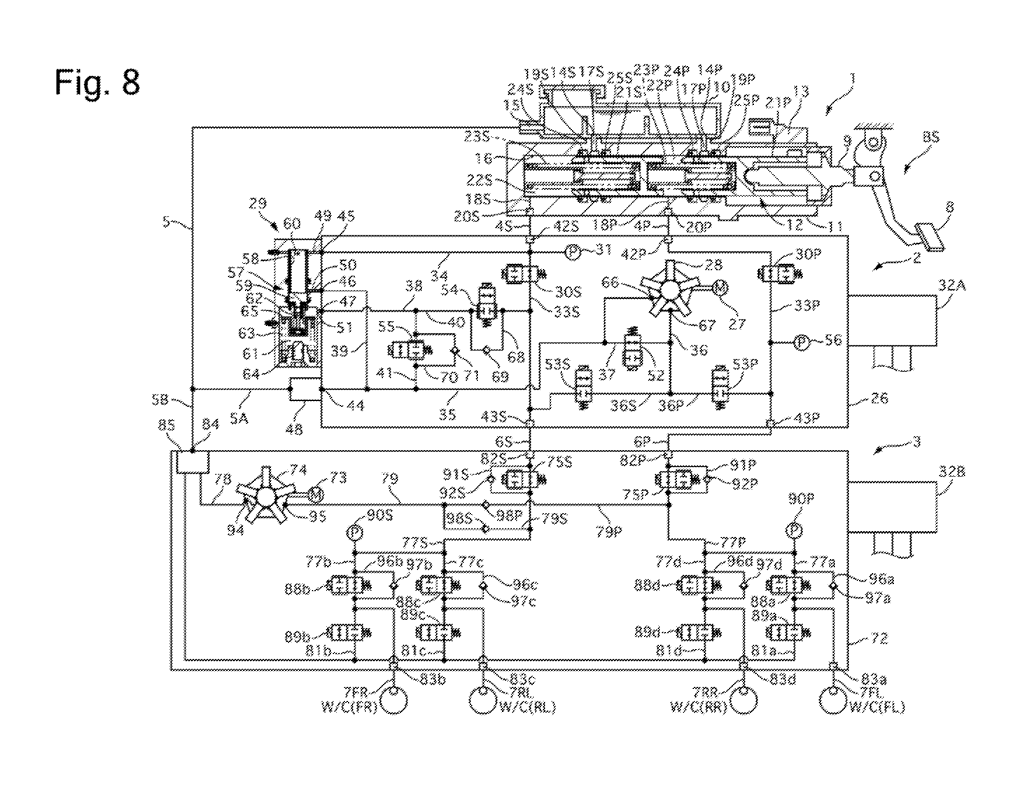

FIG. 8 illustrates a schematic configuration of the brake system BS according to the second embodiment together with the hydraulic circuit. The second hydraulic unit 3 according to the second embodiment does not include the second discharge pressure sensor 76, the second return flow fluid passage 80, the second communication valves 87, and the second pressure adjustment valve 86 illustrated in FIG. 1. A check valve 98P of the P system (a primary system second check valve) is disposed in the discharge fluid passage 79P of the P system. The check valve 98P permits only a flow of the brake fluid directed from the second discharge port 95 side of the second pump 74 toward the second connection fluid passage 77P side. A check valve 98S of the S system (a secondary system second check valve) is disposed in the discharge fluid passage 79S of the S system. The check valve 98S permits only a flow of the brake fluid directed from the second discharge port 95 side of the second pump 74 toward the second connection fluid passage 77S side.

The first electronic control unit 32A controls the number of rotations of the first motor 27, and the opening/closing operations of the first shut-off valves 30, the first pressure adjustment valve 52, the first communication valves 53, the stroke simulator IN valve 54, and the stroke simulator OUT valve 55. The second electronic control unit 32B controls the number of rotations of the second motor 73, and the opening/closing operations of the second shut-off valves 75, the solenoid IN valves 88, and the solenoid OUT valves 89. The control method conforms to the first embodiment, and therefore a description thereof will be omitted here.

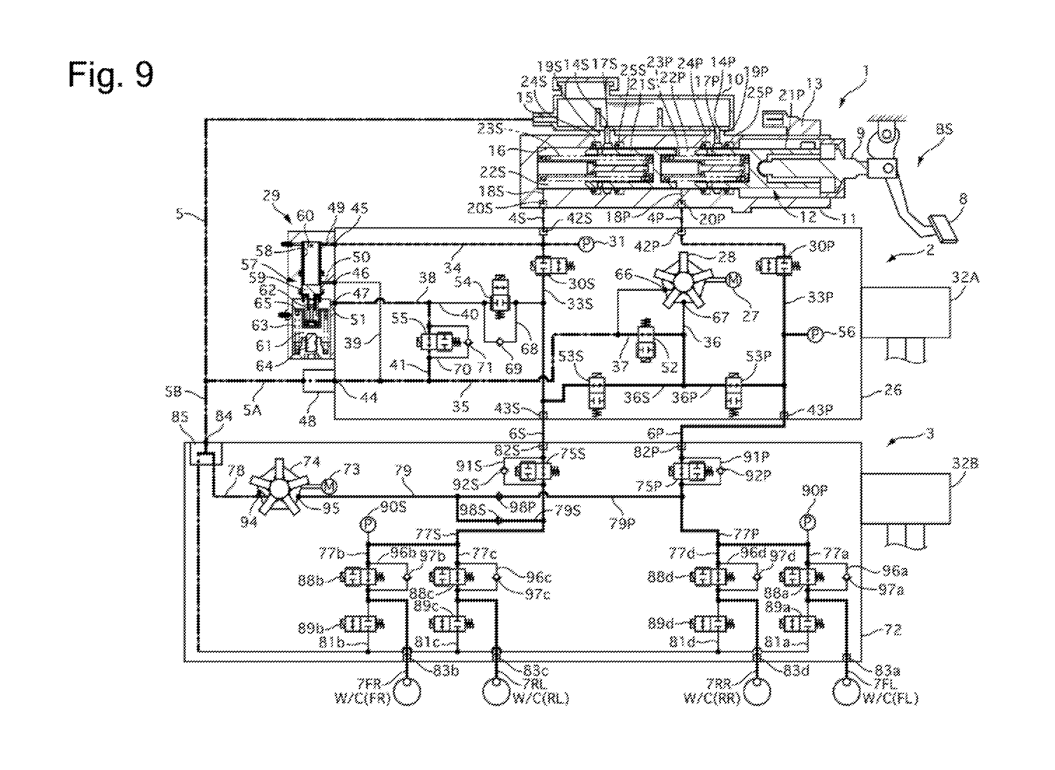

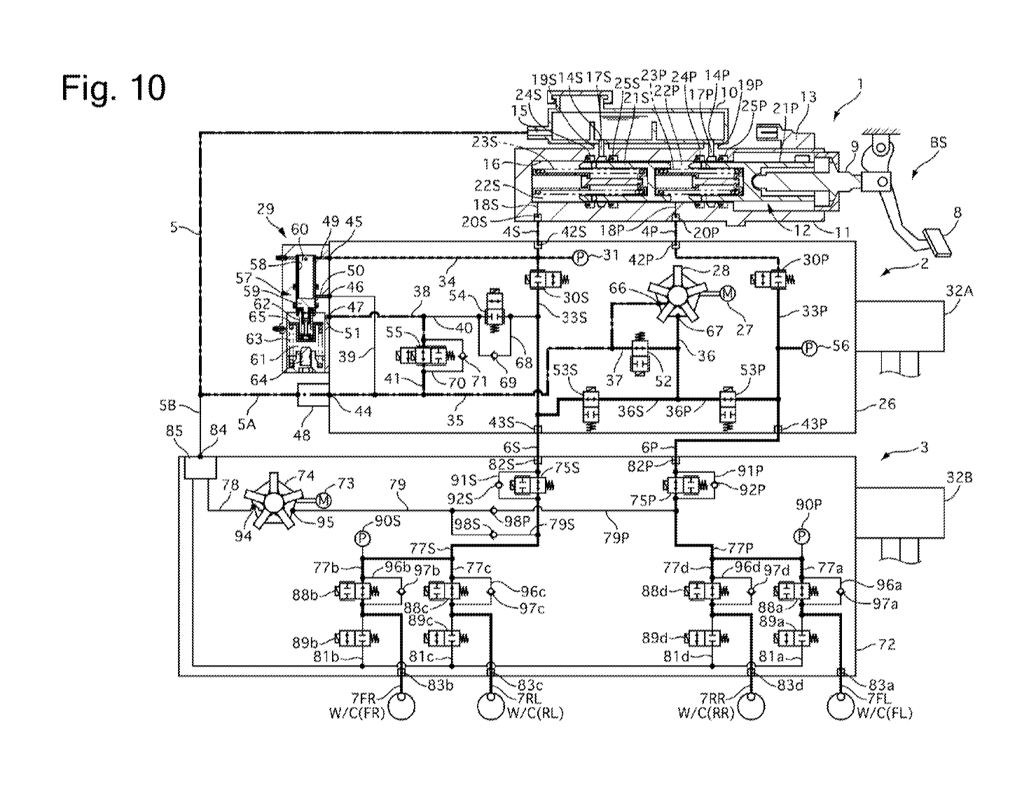

FIG. 9 illustrates an operation of the brake system BS when a failure has occurred in the first pump. When a failure has occurred in the first pump 28, the brake system BS actuates the second pump 74, and therefore can continue the boosting control. FIG. 10 illustrates an operation of the brake system BS when a failure has occurred in the second pump. When a failure has occurred in the second pump 74, the brake system BS actuates the first pump 28, and therefore can continue the boosting control. The second hydraulic unit 3 according to the second embodiment does not include the second communication valves 87 according to the first embodiment. Therefore, the second hydraulic unit 3 cannot block the flow of the brake fluid directed from the second discharge port 95 side of the second pump 74 toward the second connection fluid passages 77 side. Therefore, when a fluid leak has occurred in the wheel cylinder pipe 7 of the P system or the S system, this fluid leak cannot be stopped. However, when the fluid leak failure has occurred, a sufficient pump discharge flow rate is acquired by the actuation of the two pumps 28 and 74. Therefore, even if the brake fluid leaks to some degree, the brake system BS can sufficiently increase the pressures in the wheel cylinders W/C at the other wheels, thereby securing the required braking force. When the fluid leak is detected, it is preferable to issue some alert and prompt the driver to stop the vehicle.

In the second hydraulic unit 3 according to the second embodiment, the check valve 98P, which permits the flow of the brake fluid toward the second connection fluid passage 77P, is disposed in the discharge fluid passage 79P of the P system. Further, the check valve 98S, which permits the flow of the brake fluid toward the second connection fluid passage 77S, is disposed in the discharge fluid passage 79S of the S system. This configuration eliminates the necessity of the second communication valves 87P and 87S according to the first embodiment, thereby achieving a reduction in the number of the electromagnetic valves compared to the first embodiment.

### Third Embodiment

Next, a third embodiment will be described. The third embodiment is configured basically similarly to the first embodiment, and therefor will be described focusing on only different configurations from the first embodiment.

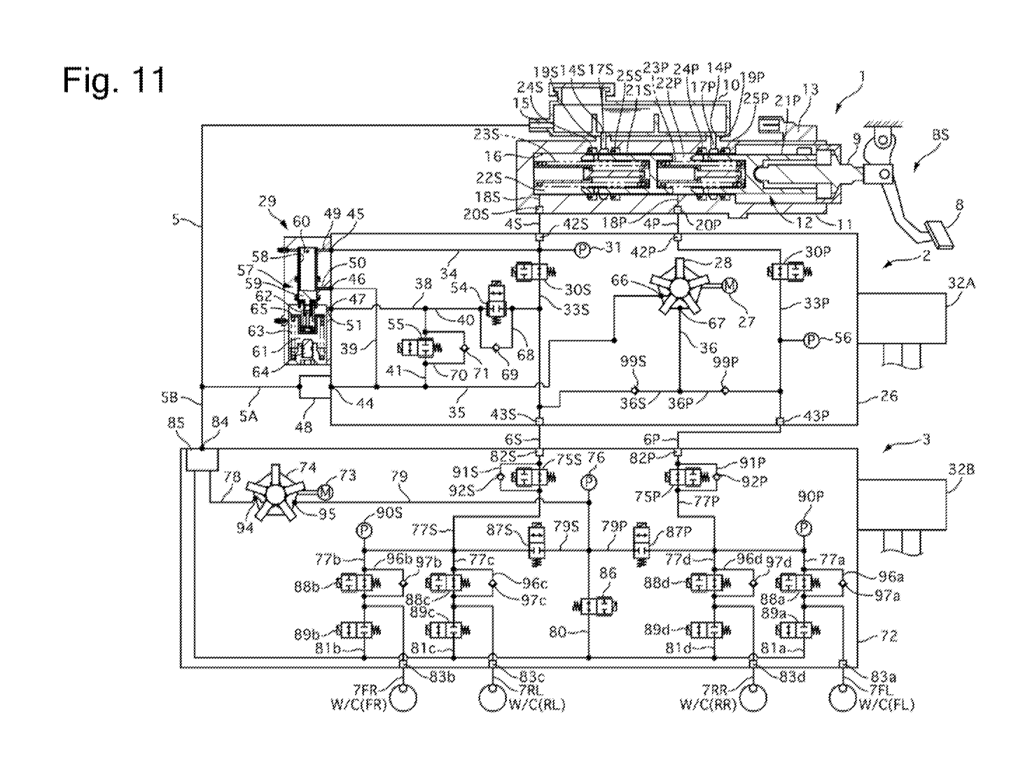

FIG. 11 illustrates a schematic configuration of the brake system BS according to the third embodiment together with the hydraulic circuit. The first hydraulic unit 2 according to the third embodiment does not include the first return flow fluid passage 37, the first pressure adjustment valve 52, and the first communication valves 53 illustrated in FIG. 1. A check valve 99P of the P system is disposed in the discharge fluid passage 36P of the P system. The check valve 99P permits only a flow of the brake fluid directed from the first discharge port 67 side of the first pump 28 toward the first connection fluid passage 33P side. A check valve 99S of the S system is disposed in the discharge fluid passage 36S of the S system. The check valve 99S permits only a flow of the brake fluid directed from the first discharge port 67 side of the first pump 28 toward the first connection fluid passage 33S side. The first electronic control unit 32A controls the number of rotations of the first motor 27, and the opening/closing operations of the first shut-off valves 30, the stroke simulator IN valve 54, and the stroke simulator OUT valve 55. The second electronic control unit 32B controls the number of rotations of the second motor 73, and the opening/closing operations of the second shut-off valves 75, the second pressure adjustment valve 86, the second communication valves 87, the solenoid IN valves 88, and the solenoid OUT valves 89. The control method conforms to the first embodiment, and therefore a description thereof will be omitted here.

### Fourth Embodiment

Next, a fourth embodiment will be described. The fourth embodiment is configured basically similarly to the first embodiment, and therefor will be described focusing on only different configurations from the first embodiment.

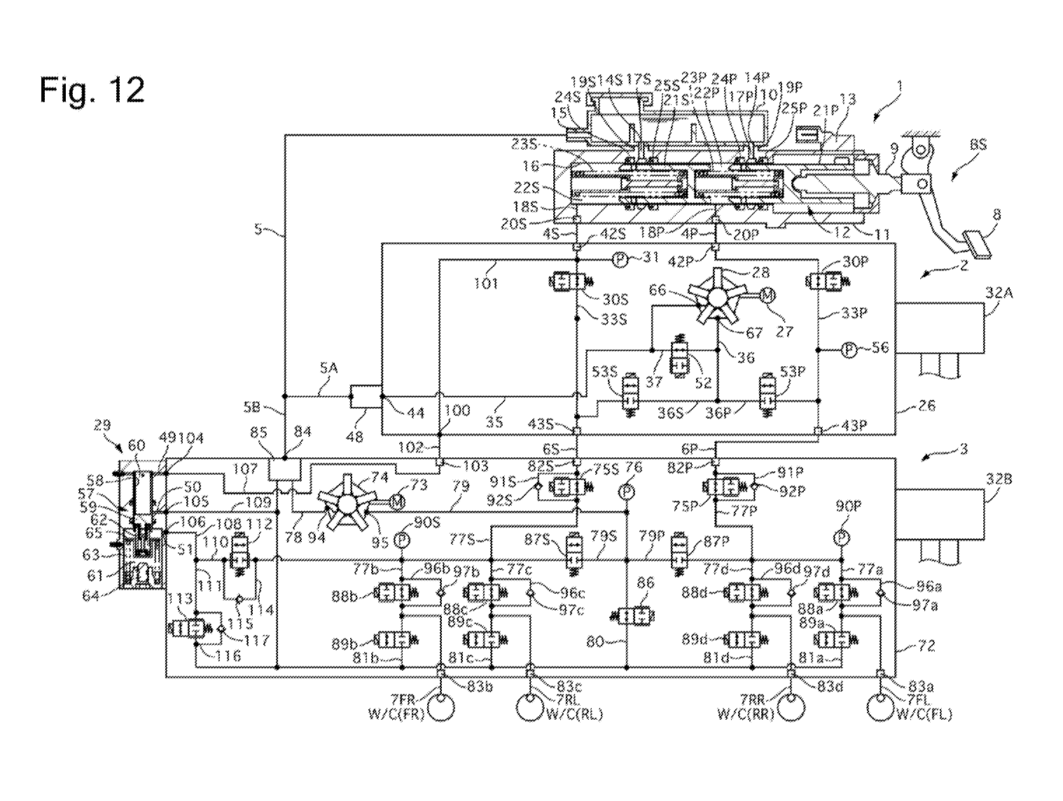

FIG. 12 illustrates a schematic configuration of the brake system BS according to the fourth embodiment together with the hydraulic circuit. The first hydraulic unit 2 according to the fourth embodiment does not include the stroke simulator unit 29, the stroke simulator fluid passage 34, the back-pressure fluid passage 38, the replenishment fluid passage 39, the first simulator fluid passage 40, the second simulator fluid passage 41, the simulator connection port 45, the replenishment port 46, the back-pressure port 47, the stroke simulator IN valve 54, the stroke simulator OUT valve 55, the bypass fluid passage 68, the check valve 69, the bypass fluid passage 70, and the check valve 71 illustrated in FIG. 1. The first hydraulic unit housing 26 includes a third output port. The third output port 100 is connected to one end side of a stroke simulator fluid passage 101. The third output port 100 is connected to a stroke simulator pipe 102. The other end side of the stroke simulator fluid passage 101 is connected to a position in the first connection fluid passage 33S on the first input port 42S side with respect to the first shut-off valve 30S.

The second hydraulic unit housing 72 includes a third input port 103, a simulator connection port 104, a replenishment port 105, and a back-pressure port 106. The third input port 103 is connected to the stroke simulator pipe 102. The stroke simulator connection port 104 is connected to the simulator connection fluid passage 49 of the stroke simulator unit 29. The replenishment port 105 is connected to the replenishment fluid passage 50 of the stroke simulator unit 29. The back-pressure port 106 is connected to the back-pressure fluid passage 51 of the stroke simulator unit 29.

The second hydraulic unit 3 according to the fourth embodiment includes the stroke simulator unit 29, a stroke simulator fluid passage 107, a back-pressure fluid passage 108, a replenishment fluid passage 109, a first simulator fluid passage 110, a second simulator fluid passage 111, a stroke simulator IN valve 112, and a stroke simulator OUT valve 113. One end side of the stroke simulator fluid passage 107 is connected to the third input port 103. The other end side of the stroke simulator fluid passage 107 is connected to the simulator connection port 104. The back-pressure fluid passage 108 is connected to the back-pressure port 106. One end side of the replenishment fluid passage 109 is connected to the replenishment port 105. The other end side of the replenishment fluid passage 109 is connected to the second return flow fluid passage 80. One end side of the first simulator fluid passage 110 is connected to the back-pressure fluid passage 108. The other end side of the first simulator fluid passage 110 is connected to a position in the second connection fluid passage 77S on the second output ports 83 side with respect to the second shut-off valve 75S and on the second input port 82S side with respect to the solenoid IN valves 71b and 71c. A stroke simulator IN valve 112 is disposed in the first simulator fluid passage 110. A bypass fluid passage 114 is disposed in parallel with the first simulator fluid passage 110 while bypassing the stroke simulator IN valve 112. A check valve 115 is disposed in the bypass fluid passage 114. The check valve 115 permits only a flow of the brake fluid directed from the back-pressure fluid passage 108 side toward the second connection fluid passage 77S side. One end side of the second simulator fluid passage 111 is connected to the back-pressure fluid passage 108. The other end side of the second simulator fluid passage 111 is connected to the second return flow fluid passage 80. A stroke simulator OUT valve 113 is disposed in the second simulator fluid passage 111. A bypass fluid passage 116 is disposed in parallel with the second simulator fluid passage 111 while bypassing the stroke simulator OUT valve 113. A check valve 117 is disposed in the bypass fluid passage 116. The check valve 117 permits only a flow of the brake fluid directed from the second return flow fluid passage 80 side toward the back-pressure fluid passage 108 side.

The first electronic control unit 32A controls the number of rotations of the first motor 27, and the opening/closing operations of the first shut-off valves 30, the first pressure adjustment valve 52, and the first communication valves 53. The second electronic control unit 32B controls the number of rotations of the second motor 73, and the opening/closing operations of the second shut-off valves 75, the second pressure adjustment valve 86, the second communication valves 87, the solenoid IN valves 88, the solenoid OUT valves 89, the stroke simulator IN valve 112, and the stroke simulator OUT valve 113. The control method conforms to the first embodiment, and therefore a description thereof will be omitted here.

In the fourth embodiment, the stroke simulator unit 29 is provided on the second hydraulic unit 3 side, which contributes to a reduction in the size of the first hydraulic unit 2 side. Further, the brake system BS can increase the volume of the first pump 28 of the first hydraulic unit 2 according to a vehicle size class and allow the second hydraulic unit 3 to be shared among various specifications, thereby improving design flexibility.

### Other Embodiments

Having described the embodiments for implementing the present invention, the specific configuration of the present invention is not limited to the configurations of the embodiments, and the present invention also includes a design modification and the like thereof made within a range that does not depart from the spirit of the present invention. Further, the individual components described in the claims and the specification can be arbitrarily combined or omitted within a range that allows them to remain capable of achieving at least a part of the above-described objects or producing at least a part of the above-described advantageous effects. For example, the hydraulic control apparatus may include three or more hydraulic sources.

In the following description, other configurations recognizable from the above-described embodiments will be described.

A hydraulic control apparatus, in one configuration thereof, includes a connection fluid passage connected to a wheel cylinder of a wheel; a first hydraulic source including a first discharge port connected to the connection fluid passage and a first intake port connected to a reservoir storing brake fluid therein; and a second hydraulic source including a second discharge port connected to the connection fluid passage and a second intake port connected to the reservoir.

According to a further preferable configuration, in the above-described configuration, the hydraulic control apparatus further includes a first intake fluid passage connecting the reservoir and the first intake port to each other, a first discharge fluid passage connecting the first discharge port and the connection fluid passage to each other, a first return flow fluid passage connecting the first intake fluid passage and the first discharge fluid passage to each other, a first pressure adjustment valve provided in the first return flow fluid passage and configured to adjust a hydraulic pressure in the wheel cylinder, a second intake fluid passage connecting the reservoir and the second intake port to each other, a second discharge fluid passage connecting the second discharge port and the connection fluid passage to each other, a second return flow fluid passage connecting the second intake fluid passage and the second discharge fluid passage to each other, and a second pressure adjustment valve provided in the second return flow fluid passage and configured to adjust the hydraulic pressure in the wheel cylinder.

According to another preferable configuration, in any of the above-described configurations, the wheel cylinder includes a wheel cylinder of a primary system and a wheel cylinder of a secondary system. The connection fluid passage includes a primary system connection fluid passage connected to the wheel cylinder of the primary system and a secondary system connection fluid passage connected to the wheel cylinder of the secondary system. The hydraulic control apparatus further includes a first communication fluid passage connecting the primary system connection fluid passage and the secondary system connection fluid passage to each other and connected to the first discharge fluid passage, a primary system first communication valve provided in the first communication fluid passage and configured to prohibit or reduce a flow of the brake fluid toward the primary system connection fluid passage, a secondary system first communication valve provided in the first communication fluid passage and configured to prohibit or reduce a flow of the brake fluid toward the secondary system connection fluid passage, a second communication fluid passage connecting the primary system connection fluid passage and the secondary system connection fluid passage to each other and connected to the second discharge fluid passage, a primary system second communication valve provided in the second communication fluid passage and configured to prohibit or reduce a flow of the brake fluid toward the primary system connection fluid passage, and a secondary system second communication valve provided in the second communication fluid passage and configured to prohibit or reduce a flow of the brake fluid toward the secondary system connection fluid passage.

According to further another preferable configuration, in any of the above-described configurations, the hydraulic control apparatus further includes a control unit configured to control each of the hydraulic sources, each of the pressure adjustment valves, and each of the communication valves. The control unit closes the primary system first communication valve and the primary system second communication valve when the brake fluid leaks from the wheel cylinder of the primary system, and closes the secondary system first communication valve and the secondary system second communication valve when the brake fluid leaks from the wheel cylinder of the secondary system.

According to further another preferable configuration, in any of the above-described configurations, the hydraulic control apparatus further includes a control unit configured to control each of the hydraulic sources, each of the pressure adjustment valves, and each of the communication valves. The control unit closes the primary system first communication valve and the secondary system first communication valve when a failure has occurred in the first hydraulic source, and closes the primary system second communication valve and the secondary system second communication valve when a failure has occurred in the second hydraulic source.

According to further another preferable configuration, in any of the above-described configurations, the hydraulic control apparatus further includes a control unit configured to control each of the hydraulic sources and each of the pressure adjustment valves. The control unit actuates only one of the first hydraulic source and the second hydraulic source.

According to further another preferable configuration, in any of the above-described configurations, the hydraulic control apparatus further includes a control unit configured to control each of the hydraulic sources and each of the pressure adjustment valves. The control unit actuates both the first hydraulic source and the second hydraulic source.

According to further another preferable configuration, in any of the above-described configurations, the wheel cylinder includes a wheel cylinder of a primary system and a wheel cylinder of a secondary system. The connection fluid passage includes a primary system connection fluid passage connected to the wheel cylinder of the primary system, and a secondary system connection fluid passage connected to the wheel cylinder of the secondary system. The hydraulic control apparatus further includes a first intake fluid passage connecting the reservoir and the first intake port to each other, a first discharge fluid passage connecting the first discharge port and the connection fluid passage to each other, a first return flow fluid passage connecting the first intake fluid passage and the first discharge fluid passage to each other, a first pressure adjustment valve provided in the first return flow fluid passage and configured to adjust a hydraulic pressure in the wheel cylinder, a second intake fluid passage connecting the reservoir and the second intake port to each other, a primary system second discharge fluid passage connecting the second discharge port and the primary system connection fluid passage to each other, a primary system second check valve provided in the primary system second discharge fluid passage and configured to permit a flow of the brake fluid toward the primary system connection fluid passage, a secondary system second discharge fluid passage connecting the second discharge port and the secondary system connection fluid passage to each other, and a secondary system second check valve provided in the secondary system second discharge fluid passage and configured to permit a flow of the brake fluid toward the secondary system connection fluid passage.

According to further another preferable configuration, in any of the above-described configurations, the hydraulic control apparatus further includes a first communication fluid passage connecting the primary system connection fluid passage and the secondary system connection fluid passage to each other and connected to the first discharge fluid passage, a primary system first communication valve provided in the first communication fluid passage and configured to prohibit or reduce a flow of the brake fluid toward the primary system connection fluid passage, and a secondary system first communication valve provided in the first communication fluid passage and configured to prohibit or reduce a flow of the brake fluid toward the secondary system connection fluid passage.

According to further another preferable configuration, in any of the above-described configurations, the hydraulic control apparatus further includes a control unit configured to control each of the hydraulic sources, the first pressure adjustment valve, and each of the communication valves. The control unit closes the primary system first communication valve and the secondary system first communication valve when a failure has occurred in the first hydraulic source, and opens the primary system first communication valve and the secondary system first communication valve when a failure has occurred in the second hydraulic source.

According to further another preferable configuration, in any of the above-described configurations, one end side of the connection fluid passage is connected to the wheel cylinder, and the other end side of the connection fluid passage is connected to a master cylinder.

According to further another preferable configuration, in any of the above-described configurations, the hydraulic control apparatus further includes a first discharge fluid passage connecting the first discharge port and the connection fluid passage to each other, a first shut-off valve provided between a position at which the connection fluid passage and the first discharge fluid passage are connected to each other, and the master cylinder, a second discharge fluid passage connecting the second discharge port and the connection fluid passage to each other, and a second shut-off valve provided between the position at which the connection fluid passage and the first discharge fluid passage are connected to each other, and a position at which the connection fluid passage and the second discharge fluid passage are connected to each other.

Further, from another aspect, a hydraulic control apparatus, in some configuration, includes a first hydraulic unit and a second hydraulic unit. The first hydraulic unit includes a first reservoir connection port connected to a reservoir storing brake fluid therein, a first hydraulic source connected to the first reservoir connection port and configured to introduce the brake fluid therein, and a first output port configured to output the brake fluid discharged from the first hydraulic source. The second hydraulic unit includes a second input port configured to receive an input of the brake fluid output from the first output port, a second reservoir connection port connected to the reservoir, a second hydraulic source connected to the second reservoir connection port and configured to introduce the brake fluid therein, and a second output port configured to output the brake fluid discharged from the second hydraulic source to a wheel cylinder of a wheel.

Preferably, in the above-described configuration, the first hydraulic unit includes a first input port connected to a master cylinder.

According to another preferable configuration, in any of the above-described configurations, the first hydraulic unit includes a first connection fluid passage connecting the first input port and the first output port to each other, and a first shut-off valve provided in the first connection fluid passage. The second hydraulic unit includes a second connection fluid passage connecting the second input port and the second output port to each other, and a second shut-off valve provided in the second connection fluid passage.

According to further another preferable configuration, in any of the above-described configurations, the first hydraulic unit includes a first intake fluid passage connecting the reservoir and an intake port of the first hydraulic source to each other, a first discharge fluid passage connecting a discharge port of the first hydraulic source and a portion in the first connection fluid passage between the first shut-off valve and the first output port to each other, a first return flow fluid passage connecting the first intake fluid passage and the first discharge fluid passage to each other, and a first pressure adjustment valve provided in the first return flow fluid passage and configured to adjust a hydraulic pressure in the wheel cylinder. The second hydraulic unit includes a second intake fluid passage connecting the reservoir and an intake port of the second hydraulic source to each other, a second discharge fluid passage connecting a discharge port of the second hydraulic source and a portion in the second connection fluid passage between the second shut-off valve and the second output port to each other, a second return flow fluid passage connecting the second intake fluid passage and the second discharge fluid passage to each other, and a second pressure adjustment valve provided in the second return flow fluid passage and configured to adjust the hydraulic pressure in the wheel cylinder.

According to further another preferable configuration, in any of the above-described configurations, the first hydraulic unit includes a first intake fluid passage connecting the reservoir and an intake port of the first hydraulic source to each other, a first discharge fluid passage connecting a discharge port of the first hydraulic source and a portion in the first connection fluid passage between the first shut-off valve and the first output port to each other, a first return flow fluid passage connecting the first intake fluid passage and the first discharge fluid passage to each other, and a first pressure adjustment valve provided in the first return flow fluid passage and configured to adjust a hydraulic pressure in the wheel cylinder. The wheel cylinder includes a wheel cylinder of a primary system and a wheel cylinder of a secondary system. The second connection fluid passage includes a primary system second connection fluid passage connected to the wheel cylinder of the primary system, and a secondary system second connection fluid passage connected to the wheel cylinder of the secondary system. The second hydraulic unit includes a second intake fluid passage connecting the reservoir and an intake port of the second hydraulic source to each other, a primary system second discharge fluid passage connecting a discharge port of the second hydraulic source and the primary system second connection fluid passage to each other, a primary system second check valve provided in the primary system second discharge fluid passage and configured to permit a flow of the brake fluid toward the primary system second connection fluid passage, a secondary system second discharge fluid passage connecting the discharge port of the second hydraulic source and the secondary system second connection fluid passage to each other, and a secondary system second check valve provided in the secondary system second discharge fluid passage and configured to permit a flow of the brake fluid toward the secondary system second connection fluid passage.

According to further another preferable configuration, in any of the above-described configurations, the hydraulic control apparatus further includes a stroke simulator unit provided in the first hydraulic unit. The stroke simulator unit includes a stroke simulator configured to generate a reaction force of the brake pedal operation, a simulator connection fluid passage, one end side of which is connected to the stroke simulator, and a simulator connection port provided on the other end side of the simulator connection fluid passage.

According to further another preferable configuration, in any of the above-described configurations, the hydraulic control apparatus further includes a stroke simulator unit provided in the second hydraulic unit. The stroke simulator unit includes a stroke simulator configured to generate a reaction force of the brake pedal operation, a simulator connection fluid passage, one end side of which is connected to the stroke simulator, and a simulator connection port provided on the other end side of the simulator connection fluid passage.

Further, from another aspect, a brake system includes a master cylinder unit, a first hydraulic unit, and a second hydraulic unit. The master cylinder unit includes a reservoir storing brake fluid therein, and a master cylinder configured to increase a pressure of the brake fluid supplied from the reservoir according to a brake pedal operation. The first hydraulic unit includes a first input port configured to receive an input of the brake fluid output from the master cylinder, a first reservoir connection port connected to the reservoir, a first hydraulic source connected to the first reservoir connection port and configured to introduce the brake fluid therein, and a first output port configured to output the brake fluid discharged from the first hydraulic source. The second hydraulic unit includes a second input port configured to receive an input of the brake fluid output from the first output port, a second reservoir connection port connected to the reservoir, a second hydraulic source connected to the second reservoir connection port and configured to introduce the brake fluid therein, and a second output port configured to output the brake fluid discharged from the second hydraulic source to a wheel cylinder of a wheel.

The present application claims priority to Japanese Patent Application No. 2016-106289 filed on May 27, 2016. The entire disclosure of Japanese Patent Application No. 2016-106289 filed on May 27, 2016 including the specification, the claims, the drawings, and the abstract is incorporated herein by reference in its entirety.

### REFERENCE SIGN LIST

BS brake system
FL to RR wheel
W/C wheel cylinder
1 master cylinder unit
2 first hydraulic unit (hydraulic control apparatus)
3 second hydraulic unit (hydraulic control apparatus)
4P first primary pipe (connection fluid passage, primary system connection fluid passage)
4S first secondary pipe (connection fluid passage, secondary system connection fluid passage)
7 wheel cylinder pipe (connection fluid passage)
10 reservoir tank (reservoir)
12 master cylinder
28 first pump (first hydraulic source)
33 first connection fluid passage (connection fluid passage)
44 first reservoir connection port
66 first intake port
67 first discharge port
74 second pump (second hydraulic source)
82 second input port
83 second output port
84 second reservoir connection port
94 second intake port
95 second discharge port

1. A hydraulic control apparatus comprising:
a connection fluid passage connected to a wheel cylinder of a wheel;
a first hydraulic source including a first discharge port connected to the connection fluid passage and a first intake port connected to a reservoir storing brake fluid therein; and
a second hydraulic source including a second discharge port connected to the connection fluid passage and a second intake port connected to the reservoir.

2. The hydraulic control apparatus according to claim 1, further comprising:
a first intake fluid passage connecting the reservoir and the first intake port to each other;
a first discharge fluid passage connecting the first discharge port and the connection fluid passage to each other;
a first return flow fluid passage connecting the first intake fluid passage and the first discharge fluid passage to each other;
a first pressure adjustment valve provided in the first return flow fluid passage and configured to adjust a hydraulic pressure in the wheel cylinder;
a second intake fluid passage connecting the reservoir and the second intake port to each other;
a second discharge fluid passage connecting the second discharge port and the connection fluid passage to each other;
a second return flow fluid passage connecting the second intake fluid passage and the second discharge fluid passage to each other; and
a second pressure adjustment valve provided in the second return flow fluid passage and configured to adjust the hydraulic pressure in the wheel cylinder.

3. The hydraulic control apparatus according to claim 2, wherein the wheel cylinder includes a wheel cylinder of a primary system and a wheel cylinder of a secondary system,
wherein the connection fluid passage includes a primary system connection fluid passage connected to the wheel cylinder of the primary system, and a secondary system connection fluid passage connected to the wheel cylinder of the secondary system, and
wherein the hydraulic control apparatus further includes
a first communication fluid passage connecting the primary system connection fluid passage and the secondary system connection fluid passage to each other, and connected to the first discharge fluid passage,
a primary system first communication valve provided in the first communication fluid passage and configured to prohibit or reduce a flow of the brake fluid toward the primary system connection fluid passage,
a secondary system first communication valve provided in the first communication fluid passage and configured to prohibit or reduce a flow of the brake fluid toward the secondary system connection fluid passage,
a second communication fluid passage connecting the primary system connection fluid passage and the secondary system connection fluid passage to each other, and connected to the second discharge fluid passage,
a primary system second communication valve provided in the second communication fluid passage and configured to prohibit or reduce a flow of the brake fluid toward the primary system connection fluid passage, and
a secondary system second communication valve provided in the second communication fluid passage and configured to prohibit or reduce a flow of the brake fluid toward the secondary system connection fluid passage.

4. The hydraulic control apparatus according to claim 3, further comprising a control unit configured to control each of the hydraulic sources, each of the pressure adjustment valves, and each of the communication valves,
wherein the control unit closes the primary system first communication valve and the primary system second communication valve when the brake fluid leaks from the wheel cylinder of the primary system, and closes the secondary system first communication valve and the secondary system second communication valve when the brake fluid leaks from the wheel cylinder of the secondary system.

5. The hydraulic control apparatus according to claim 3, further comprising a control unit configured to control each of the hydraulic sources, each of the pressure adjustment valves, and each of the communication valves,
wherein the control unit closes the primary system first communication valve and the secondary system first communication valve when a failure occurs in the first hydraulic source, and closes the primary system second communication valve and the secondary system second communication valve when a failure occurs in the second hydraulic source.

6. The hydraulic control apparatus according to claim 2, further comprising a control unit configured to control each of the hydraulic sources and each of the pressure adjustment valves,
wherein the control unit actuates only one of the first hydraulic source and the second hydraulic source.

7. The hydraulic control apparatus according to claim 2, further comprising a control unit configured to control each of the hydraulic sources and each of the pressure adjustment valves,
wherein the control unit actuates both the first hydraulic source and the second hydraulic source.

8. The hydraulic control apparatus according to claim 1, wherein the wheel cylinder includes a wheel cylinder of a primary system and a wheel cylinder of a secondary system,
wherein the connection fluid passage includes a primary system connection fluid passage connected to the wheel cylinder of the primary system, and a secondary system connection fluid passage connected to the wheel cylinder of the secondary system, and
wherein the hydraulic control apparatus further includes
a first intake fluid passage connecting the reservoir and the first intake port to each other,
a first discharge fluid passage connecting the first discharge port and the connection fluid passage to each other,
a first return flow fluid passage connecting the first intake fluid passage and the first discharge fluid passage to each other,
a first pressure adjustment valve provided in the first return flow fluid passage and configured to adjust a hydraulic pressure in the wheel cylinder,
a second intake fluid passage connecting the reservoir and the second intake port to each other,
a primary system second discharge fluid passage connecting the second discharge port and the primary system connection fluid passage to each other,
a primary system second check valve provided in the primary system second discharge fluid passage and configured to permit a flow of the brake fluid toward the primary system connection fluid passage,
a secondary system second discharge fluid passage connecting the second discharge port and the secondary system connection fluid passage to each other, and
a secondary system second check valve provided in the secondary system second discharge fluid passage and configured to permit a flow of the brake fluid toward the secondary system connection fluid passage.

9. The hydraulic control apparatus according to claim 8, further comprising:
a first communication fluid passage connecting the primary system connection fluid passage and the secondary system connection fluid passage to each other, and connected to the first discharge fluid passage;
a primary system first communication valve provided in the first communication fluid passage and configured to prohibit or reduce a flow of the brake fluid toward the primary system connection fluid passage; and
a secondary system first communication valve provided in the first communication fluid passage and configured to prohibit or reduce a flow of the brake fluid toward the secondary system connection fluid passage.

10. The hydraulic control apparatus according to claim 9, further comprising a control unit configured to control each of the hydraulic sources, the first pressure adjustment valve, and each of the communication valves,
wherein the control unit closes the primary system first communication valve and the secondary system first communication valve when a failure occurs in the first hydraulic source, and opens the primary system first communication valve and the secondary system first communication valve when a failure occurs in the second hydraulic source.

11. The hydraulic control apparatus according to claim 1, wherein one end side of the connection fluid passage is connected to the wheel cylinder, and an opposite end side of the connection fluid passage is connected to a master cylinder.

12. The hydraulic control apparatus according to claim 11, further comprising:
a first discharge fluid passage connecting the first discharge port and the connection fluid passage to each other;
a first shut-off valve provided between a position at which the connection fluid passage and the first discharge fluid passage are connected to each other, and the master cylinder;
a second discharge fluid passage connecting the second discharge port and the connection fluid passage to each other; and
a second shut-off valve provided between the position at which the connection fluid passage and the first discharge fluid passage are connected to each other, and a position at which the connection fluid passage and the second discharge fluid passage are connected to each other.

13. A hydraulic control apparatus comprising:
a first hydraulic unit; and
a second hydraulic unit,
wherein the first hydraulic unit includes
a first reservoir connection port connected to a reservoir storing brake fluid therein,
a first hydraulic source connected to the first reservoir connection port and configured to introduce the brake fluid therein, and
a first output port configured to output the brake fluid discharged from the first hydraulic source, and
wherein the second hydraulic unit includes
a second input port configured to receive an input of the brake fluid output from the first output port,
a second reservoir connection port connected to the reservoir,
a second hydraulic source connected to the second reservoir connection port and configured to introduce the brake fluid therein, and
a second output port configured to output the brake fluid discharged from the second hydraulic source to a wheel cylinder of a wheel.

14. The hydraulic control apparatus according to claim 13, wherein the first hydraulic unit includes a first input port connected to a master cylinder.

15. The hydraulic control apparatus according to claim 14, wherein the first hydraulic unit includes
a first connection fluid passage connecting the first input port and the first output port to each other, and
a first shut-off valve provided in the first connection fluid passage, and
wherein the second hydraulic unit includes
a second connection fluid passage connecting the second input port and the second output port to each other, and
a second shut-off valve provided in the second connection fluid passage.

16. The hydraulic control apparatus according to claim 15, wherein the first hydraulic unit includes
a first intake fluid passage connecting the reservoir and an intake port of the first hydraulic source to each other,
a first discharge fluid passage connecting a discharge port of the first hydraulic source and a portion in the first connection fluid passage between the first shut-off valve and the first output port to each other,
a first return flow fluid passage connecting the first intake fluid passage and the first discharge fluid passage to each other, and
a first pressure adjustment valve provided in the first return flow fluid passage and configured to adjust a hydraulic pressure in the wheel cylinder, and
wherein the second hydraulic unit includes
a second intake fluid passage connecting the reservoir and an intake port of the second hydraulic source to each other,
a second discharge fluid passage connecting a discharge port of the second hydraulic source and a portion in the second connection fluid passage between the second shut-off valve and the second output port to each other,
a second return flow fluid passage connecting the second intake fluid passage and the second discharge fluid passage to each other, and
a second pressure adjustment valve provided in the second return flow fluid passage and configured to adjust the hydraulic pressure in the wheel cylinder.

17. The hydraulic control apparatus according to claim 15, wherein the first hydraulic unit includes
a first intake fluid passage connecting the reservoir and an intake port of the first hydraulic source to each other,
a first discharge fluid passage connecting a discharge port of the first hydraulic source and a portion in the first connection fluid passage between the first shut-off valve and the first output port to each other,
a first return flow fluid passage connecting the first intake fluid passage and the first discharge fluid passage to each other, and
a first pressure adjustment valve provided in the first return flow fluid passage and configured to adjust a hydraulic pressure in the wheel cylinder,
wherein the wheel cylinder includes a wheel cylinder of a primary system and a wheel cylinder of a secondary system,
wherein the second connection fluid passage includes a primary system second connection fluid passage connected to the wheel cylinder of the primary system, and a secondary system second connection fluid passage connected to the wheel cylinder of the secondary system, and
wherein the second hydraulic unit includes
a second intake fluid passage connecting the reservoir and an intake port of the second hydraulic source to each other,
a primary system second discharge fluid passage connecting a discharge port of the second hydraulic source and the primary system second connection fluid passage to each other,
a primary system second check valve provided in the primary system second discharge fluid passage and configured to permit a flow of the brake fluid toward the primary system second connection fluid passage,
a secondary system second discharge fluid passage connecting the discharge port of the second hydraulic source and the secondary system second connection fluid passage to each other, and
a secondary system second check valve provided in the secondary system second discharge fluid passage and configured to permit a flow of the brake fluid toward the secondary system second connection fluid passage.

18. The hydraulic control apparatus according to claim 13, further comprising a stroke simulator unit provided in the first hydraulic unit,
wherein the stroke simulator unit includes
a stroke simulator configured to generate a reaction force of the brake pedal operation,
a simulator connection fluid passage, one end side of which is connected to the stroke simulator, and
a simulator connection port provided on an opposite end side of the simulator connection fluid passage.

19. The hydraulic control apparatus according to claim 13, further comprising a stroke simulator unit attached to the second hydraulic unit,
wherein the stroke simulator unit includes
a stroke simulator configured to generate a reaction force of the brake pedal operation,
a simulator connection fluid passage, one end side of which is connected to the stroke simulator, and
a simulator connection port provided on an opposite end side of the simulator connection fluid passage.

20. A brake system comprising:
a master cylinder unit;
a first hydraulic unit; and
a second hydraulic unit,
wherein the master cylinder unit includes
a reservoir storing brake fluid therein, and
a master cylinder configured to increase a pressure of the brake fluid supplied from the reservoir according to a brake pedal operation,
wherein the first hydraulic unit includes
a first input port configured to receive an input of the brake fluid output from the master cylinder,
a first reservoir connection port connected to the reservoir,
a first hydraulic source connected to the first reservoir connection port and configured to introduce the brake fluid therein, and
a first output port configured to output the brake fluid discharged from the first hydraulic source, and
wherein the second hydraulic unit includes
a second input port configured to receive an input of the brake fluid output from the first output port,
a second reservoir connection port connected to the reservoir,
a second hydraulic source connected to the second reservoir connection port and configured to introduce the brake fluid therein, and
a second output port configured to output the brake fluid discharged from the second hydraulic source to a wheel cylinder of a wheel.
